(19) United States
(12) Patent Application Publication
(10) Pub. No.: US 2009/0260971 A1
(43) Pub. Date: Oct. 22, 2009

(54) METHOD OF PREPARING FLUOROALKYL COMPOUNDS USING RADIATION

(75) Inventors: Sang Wook Kim, Gyeonggi-do (KR); Min Goo Hur, Gyeonggi-do (KR); Seung Dae Yang, Jeollabuk-do (KR); Kook Hyun Yu, Seoul (KR)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(73) Assignee: Korea Atomic Energy Research Institute, Daejon (KR)

(21) Appl. No.: 12/244,536

(22) Filed: Oct. 2, 2008

(30) Foreign Application Priority Data
Apr. 22, 2008 (KR) KR10-2008-0037161

(51) Int. Cl. B01J 19/12

(52) U.S. Cl. 204/157.86

(57) ABSTRACT

Disclosed herein is a method of preparing a fluoroalkyl compound using radiation, including: mixing an alkyl compound having a leaving group with tetrabutylammonium fluoride (TBAF) in the presence of a reaction solvent at room temperature to form a mixed solution (step 1); and applying radiation to the mixed solution while stirring it to prepare a fluoroalkyl compound (step 2). The method of preparing a fluoroalkyl compound using radiation is advantageous in that fluoroalkyl compounds can be easily prepared in a short reaction time at room temperature, in that the method is safe because it is not required to use fluorine gas, which is harmful to the human body, in that the method can be usefully used to prepare fluoroalkyl compounds because the yield of fluoroalkyl compounds obtained using the method is higher than when using conventional SN2 reaction methods, and in that fluorine ¹⁸F, which is a radioactive isotope, can be easily introduced into alkyl compounds.

### BACKGROUND OF THE INVENTION

1. Field of the Invention

The present invention relates to a method of preparing fluoroalkyl compounds using radiation.

2. Description of the Related Art

The introduction of fluorine into an organic molecule can improve the activity of the organic molecule. This phenomenon has been observed in many examples in which fluorine has influenced pharmaceutical and agricultural chemistry for 20 years [H. J. Bohm, D. Banner, S. Bendels, M. Kansy, B. Kuhn, K. Muller, O, S. Ulrike, M. Stahl, Fluorine in medicinal chemistry. ChemBioChem. 2004, 5, 637˜643; M. Shimizu, T. Hiyama, Modern Synthetic methods for fluorine-substituted target molecules. Angew. Chem. Int. Ed. 2005, 44, 214˜231].

Fluorine compounds are put to various practical uses in pharmaceutical fields or general chemical reactions, and the process of introducing fluorine into specific compounds is one of very important processes. Fluorine is disadvantageous in that, since it has the strongest electronegativity among all elements, it is very difficult to introduce it into compounds, but is advantageous in that, once it is formed into fluorine compounds, it cannot be easily separated from the fluorine compounds.

As shown in the following Reaction Formula, a conventional method of introducing fluorine into alkyl compounds is performed through a process of protecting a hydroxyl group using an acetyl group, introducing fluorine thereto and then deprotecting the hydroxyl group using a strong acid. The reason for this is that a chemical reaction of separating a leaving group and introducing fluorine is conducted via a nucleophilic substitution reaction (SN2 mechanism). The nucleophilic substitution reaction proceeds when a solvent having high polarity or a solvent including no water or alcoholic hydrogen is used. Conversely, when a solvent having low polarity or a solvent including water or alcoholic hydrogen is used, the nucleophilic reaction proceeds slowly or does not occur. The reason for this is that fluorine ions, which must separate a leaving group and form a bond, form a hydrogen bond through alcoholic hydrogen included in a solvent, or are solvated by water. Further, the conventional method of introducing fluorine into alkyl compounds is problematic in that reaction temperature must be maintained at high temperature.

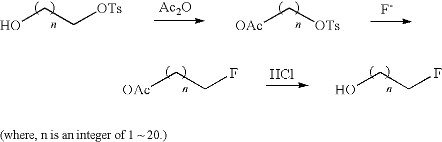

Therefore, the present inventors have researched methods of easily introducing fluorine into specific compounds at room temperature and increasing the yield of products, and, as a result, it was found that fluorine could be introduced into the specific compounds at a high yield even at room temperature when radiation is used. Based on these findings, the present invention was completed.

### SUMMARY OF THE INVENTION

Accordingly, the present invention has been made keeping in mind the above problems occurring in the prior art, and an object of the present invention is to provide a method of preparing fluoroalkyl compounds at a high yield at room temperature.

In order to accomplish the above object, the present invention provides a method of preparing a fluoroalkyl compound using radiation, including: mixing an alkyl compound having a leaving group with tetrabutylammonium fluoride (TBAF) in the presence of a reaction solvent at room temperature to form a mixed solution (step 1); and applying radiation to the mixed solution while stirring it to prepare a fluoroalkyl compound (step 2).

### BRIEF DESCRIPTION OF THE DRAWINGS

The above and other objects, features and advantages of the present invention will be more clearly understood from the following detailed description taken in conjunction with the accompanying drawings, in which:

FIG. 1 shows an NMR spectrum of 1-fluoro-4-tosyloxybutane according to an embodiment of the present invention;

FIG. 2 show the TLC results of the reaction depending on radiation according to an embodiment of the present invention (1˜4: radiation, 5: reference material (1-fluoro-4-tosyloxybutane), 6˜10: no radiation); and

FIG. 3 show the TLC results of the reaction depending on the addition of BHT according to an embodiment of the present invention (A: BHT addition, B: no BHT addition).

### DESCRIPTION OF THE PREFERRED EMBODIMENTS

Hereinafter, the present invention will be described in detail.

The present invention provides a method of preparing a fluoroalkyl compound using radiation, as represented by Reaction Formula I below, including: mixing an alkyl compound having a leaving group with tetrabutylammonium fluoride (TBAF) in the presence of a reaction solvent at room temperature to form a mixed solution (step 1); and applying radiation to the mixed solution while stirring it to prepare a fluoroalkyl compound (step 2).

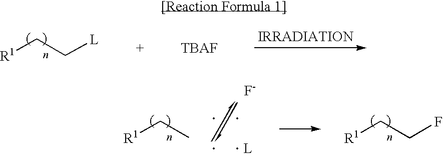

(where, R¹ is hydrogen, a methyl group, hydroxyl group or L, in which L is a leaving group, and n is an integer of 1˜20.)

First, in step 1, an alkyl compound having a leaving group is mixed with tetrabutylammonium fluoride (TBAF) in the presence of a reaction solvent at room temperature to form a mixed solution.

In the method of preparing a fluoroalkyl compound according to the present invention, the reaction solvent may be selected from among acetonitrile, dimethylsulfoxide, dimethylformamide, and hexamethylphosphoamide, but is not limited thereto.

In the method of preparing a fluoroalkyl compound according to the present invention, it is preferred that the alkyl compound be provided with a leaving group at the end thereof. The leaving group serves to enable the alkyl compound to be easily substituted with fluorine. In this case, as the leaving group, a tosyl group, a mesyl group, a nosyl group, or the like may be used.

In the method of preparing a fluoroalkyl compound according to the present invention, as fluorine (F) present in the tetrabutylammonium fluoride (TBAF), general fluorine (¹⁹F) or radioactive fluorine (¹⁸F) may be used. In this case, it is preferred that the tetrabutylammonium fluoride (TBAF) be added such that the equivalent weight thereof is the same as that of the alkyl compound. When the amount of the added TBAF is 2 equivalents or more, a compound substituted with fluorine on both sides thereof is formed because an excessive amount of the TBAF is added. This compound is problematic in that, since it has a low boiling point, it is easily volatilized in a separation process, thus decreasing the yield.

Next, in step 2, the mixed solution formed in step 1 is irradiated while being stirred, thus preparing a fluoroalkyl compound.

In the method of preparing a fluoroalkyl compound according to the present invention, as the radiation, gamma (γ) rays may be used. In this case, it is preferred that the amount of the radiation be 0.1˜30 kGy. When the amount of the radiation is less than 0.1 kGy, there is a problem in that the reaction does not occur. In contrast, when the amount thereof is more than 30 kGy, there are problems in that the cost is increased because unnecessary radiation is used, and the fluoroalkyl compound that is obtained can be decomposed.

In the preparation of a fluoroalkyl compound according to the present invention, in order to find a reaction mechanism, the yield of the product obtained by mixing TBAF with an alkyl compound to form a mixture and then applying radiation to the mixture in a state in which BHT, which can easily remove radicals, was added or not added was measured, and the results thereof are shown in Table 4. From Table 4, it was found that the product was obtained at a high yield when BHT was not added, but that almost none of the product was obtained when BHT was added. Therefore, it can be seen that the reaction mechanism in the method of preparing a fluoroalkyl compound according to the present invention is due to a radical reaction. Specifically, as shown in Reaction Formula I above, it is inferred that the end of an alkyl compound is decomposed by radiation, thus forming radicals, and that the radicals, which are unstable and thus have very high reactivity, are bonded with electrons in fluorine anions, thus preparing a fluoroalkyl compound.

The method of preparing a fluoroalkyl compound using radiation according to the present invention is advantageous in that a fluoroalkyl compound can be easily prepared in a short reaction time at room temperature, in that the method is safe because it is not required to use fluorine gas, which is harmful to the human body, in that the method can be usefully used to prepare a fluoroalkyl compound because the yield of a fluoroalkyl compound obtained using the method is higher than when using conventional SN2 reaction methods, and in that fluorine ¹⁸F, which is a radioactive isotope, can be easily introduced into alkyl compounds.

Hereinafter, the present invention will be described in more detail with reference to the following Examples. However, the scope of the present invention is not limited thereto.

### Example 1

### Preparation of 1-fluoro-4-tosyloxybutane

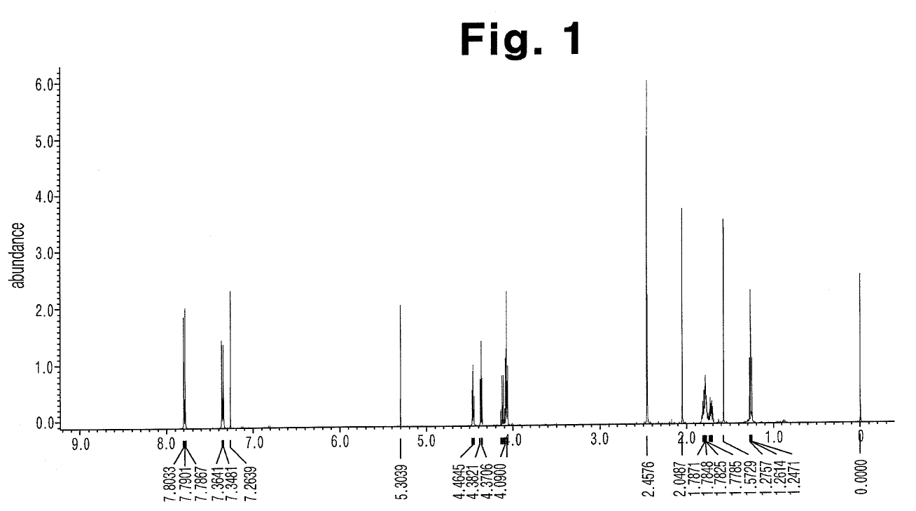

0.4 g of 1,4-ditosyloxybutane, as a precursor material, and 1 equivalent of dried tetrabutylammonium fluoride (TBAF) were dissolved in 10 ml of acetonitrile (MeCN) to form a mixed solution, and then the mixed solution was stirred while irradiating the mixed solution with 0.1 kGy of gamma rays using a gamma-ray irradiation apparatus (IR-222, MDS Nordion). Subsequently, the solvent was removed from the mixed solution, and then the resultant product was washed, dried and concentrated, thereby obtaining 1-fluoro-4-tosyloxybutane, which is a target compound, at a yield of 41% through chromatography (ethyl acetate:hexane=1:3). The NMR spectrum of the obtained 1-fluoro-4-tosyloxybutane is shown in FIG. 1.

From FIG. 1, it was found that a compound synthesized in Example 1 was 1-fluoro-4-tosyloxybutane.

### Example 2

### Preparation of 1-[¹⁸F]fluoro-4-tosyloxybutane

0.4 g of 1,4-ditosyloxybutane, as a precursor material, and 3.7 GBq (100 mCi) of dried tetrabutylammonium fluoride (TBA[¹⁸F]) were dissolved in 10 ml of acetonitrile (MeCN) to form a mixed solution, and then the mixed solution was stirred while irradiating the mixed solution with 0.1 kGy of gamma rays using a gamma-ray irradiation apparatus (IR-222, MDS Nordion). Subsequently, the solvent was removed from the mixed solution, and then the resultant product was washed, dried and concentrated, thereby obtaining 1-[¹⁸F]fluoro-4-tosyloxybutane, which is a target compound, at a yield of 40% through chromatography (ethyl acetate:hexane=1:3).

### Experimental Example 1

### Preparation of Fluoroalkyl Compound Depending on Radiation

In the preparation of a fluoroalkyl compound according to the present invention, in order to observe the influence of radiation, the following experiments were conducted.

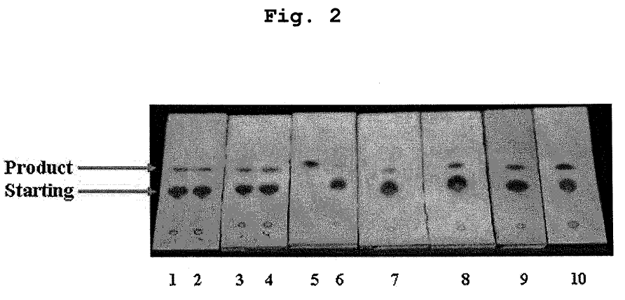

In an experimental group, 0.4 g of 1,4-ditosyloxybutane, as a precursor material, and 1 equivalent of dried tetrabutylammonium fluoride (TBAF) were dissolved in 10 ml of acetonitrile (MeCN) to form a mixed solution, and then the mixed solution was stirred while irradiating the mixed solution with 0.1 kGy of gamma rays for 12 minutes, thereby obtaining 1-fluoro-4-tosyloxybutane. In a control group, the experiment was conducted using the same method as in the experimental group, except that the irradiation with gamma rays was not conducted, and the stirring time was changed to 1˜24 hours. Thereafter, the yields of the obtained 1-fluoro-4-tosyloxybutane were measured, and the results thereof are shown in Table 1 and FIG. 2.

TABLE 1

| Class. | | Reaction time | Yield (%) |
|---|---|---|---|
| Example 1 | | 12 minutes | 41 |
| Control | 6 | 12 minutes | 2 |
| group | 7 | 38 minutes | 5 |
| | 8 | 1 hour | 7 |
| | 9 | 2 hours | 10 |
| | 10 | 24 hours | 30 |

From Table 1 and FIG. 2, it can be seen that when the irradiation of gamma rays was conducted, the fluoroalkyl compound was obtained at a yield of 41%, but when the irradiation with gamma rays was not conducted, the fluoroalkyl compound was obtained at a low yield of 30% even when the stirring time was 24 hours.

Therefore, in the method of preparing a fluoroalkyl compound using radiation according to the present invention, the fluoroalkyl compound can be efficiently prepared in a short reaction time at room temperature.

### Experimental Example 2

### Preparation of Fluoroalkyl Compound Depending on the Amount of Radiation

In the preparation of a fluoroalkyl compound according to the present invention, in order to observe the influence of the amount of radiation, the following experiments were conducted.

The experiment was conducted using the same method as in Example 1, except that the amount of gamma rays is changed to 0.1, 0.3, 0.5, or 1.0 kGy. Here, 1-fluoro-4-tosyloxybutane was prepared in this way, and then the yields of the prepared 1-fluoro-4-tosyloxybutane were measured, and the results thereof are shown in Table 2 and FIG. 2.

TABLE 2

| | Amount of gamma rays | |
|---|---|---|
| Class. | (kGy) | Yield (%) |
| 1 | 0.1 | 41 |
| 2 | 0.3 | 37 |
| 3 | 0.5 | 39 |
| 4 | 1.0 | 36 |

From Table 2 and FIG. 2, it can be seen that the yields of the products were not influenced by the amount of radiation at the time of preparing the fluoroalkyl compound.

### Experimental Example 3

### Preparation of Fluoroalkyl Compound Depending on the Amount of TBAF

In the preparation of a fluoroalkyl compound according to the present invention, in order to observe the influence of the amount of TBAF, the following experiments were conducted.

The experiment was conducted using the same method as in Example 1, except that the amount of TBAF relative to the precursor material was changed to 1, 2, or 4 equivalents. Here, 1-fluoro-4-tosyloxybutane was prepared in this way, and then the yields of the prepared 1-fluoro-4-tosyloxybutane were measured, and the results thereof are shown in Table 3.

TABLE 3

| Amount of TBAF | |
|---|---|
| (equivalent) | Yield (%) |
| 1 | 41 |
| 2 | 10 |
| 4 | 8 |

From Table 3, it was found that when the amount of TBAF relative to the precursor material was 2 or 4, the yield thereof was decreased. The reason for this is assumed to be because 1-fluoro-4-tosyloxybutane, having a low boiling point, which is provided with fluorine at both sides thereof, was formed, and was thus volatilized to the atmosphere in a separation process.

### Experimental Example 4

### Experiment of Fluorination Reaction in the Presence of Hydroxyl Group

In the preparation of a fluoroalkyl compound according to the present invention, in order to observe whether a fluorination reaction occurs even in the presence of a hydroxyl group, the following experiments were conducted.

In an experimental group, the experiment was conducted using the same method as in Example 1, except that 12-tosyloxy-1-dodecanol was used as a precursor material. In a control group, 12-fluoro-1-dodecanol was prepared by refluxing the 12-tosyloxy-1-dodecano without radiation, and then the yields thereof were measured, and the results thereof are shown in Table 4.

TABLE 4

| | Amount of gamma rays | |
|---|---|---|
| Class. | (kGy) | Yield (%) |
| Experimental | 0.1 | 40 |
| group | | |
| Control group | — | <5 |

From Table 4, it can be seen that the fluorination reaction can be effectively conducted using radiation even when a compound including a hydroxyl group is used.

### Experimental Example 5

### Observation of Reaction Mechanism

In the preparation of a fluoroalkyl compound according to the present invention, in order to observe a reaction mechanism, the following experiments were conducted.

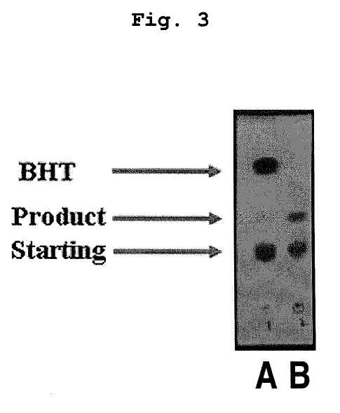

In an experimental group, 0.4 g of 1,4-ditosyloxybutane, as a precursor material, and 1 equivalent of dried or not dried tetrabutylammonium fluoride (TBAF) were mixed to form a mixture, and then the mixture was irradiated with 0.1 kGy of gamma rays at room temperature and was then stirred, thereby obtaining 1-fluoro-4-tosyloxybutane. In a comparative group, the experiment was conducted using the same method as in the experimental group, except that BHT, which can remove radicals, was added thereto, and the irradiation with gamma rays was conducted. In a control group, the experiment was conducted using the same method as in the experimental group, except that the mixture was refluxed and stirred without irradiating it with gamma rays. Thereafter, the yields of the 1-fluoro-4-tosyloxybutane obtained in the groups were measured, and the results thereof are shown in Table 5 and FIG. 3.

TABLE 5

| | State of | Amount of gamma | |
|---|---|---|---|
| Class. | TBAF | rays (kGy) | Yield (%) |
| Experimental | not dried | 0.1 | 44 |
| group | | | |
| Comparative | not dried | 0.1/BHT addition | — |
| group | | | |
| Control | dried | — | <5 |
| group | | | |

BHT, which is a compound capable of easily removing radicals, was used in a comparative group because it was predicted that the BHT absorbed radicals, and thus prevented a radical formation reaction from occurring.

As a result, as shown in Table 4 and FIG. 3, when gamma rays were irradiated without adding BHT thereto, the reaction proceeded, thus obtaining a fluoroalkyl compound at a yield of 44%. However, when BHT was added thereto, the fluoroalkyl compound was not produced.

Further, in a general SN2 reaction mechanism, almost none of a reaction product is produced in a state in which water is not removed from TBAF. However, due to the irradiation with gamma rays, the reaction product was produced at a high yield.

Therefore, it can be seen that the reaction mechanism in the method of preparing a fluoroalkyl compound according to the present invention is due to a radical reaction.

As described above, the method of preparing fluoroalkyl compounds using radiation according to the present invention is advantageous in that fluoroalkyl compounds can be easily prepared in a short reaction time at room temperature, in that the method is safe because it is not necessary to use fluorine gas, which is harmful to the human body, in that the method can be usefully used to prepare fluoroalkyl compounds because the yield of fluoroalkyl compounds obtained using the method is higher than when using conventional SN2 reaction methods, and in that fluorine ¹⁸F, which is a radioactive isotope, can be easily introduced into alkyl compounds.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of preparing a fluoroalkyl compound using radiation, as represented by Reaction Formula I below, comprising:
mixing an alkyl compound having a leaving group with tetrabutylammonium fluoride (TBAF) in the presence of a reaction solvent at room temperature to form a mixed solution (step 1); and
applying radiation to the mixed solution while stirring it to prepare a fluoroalkyl compound (step 2). 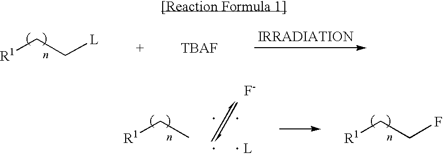
(where, R¹ is hydrogen, a methyl group, hydroxyl group or L, in which L is a leaving group, and n is an integer of 1˜20.)

2. The method of preparing a fluoroalkyl compound using radiation according to claim 1, wherein the reaction solvent is selected from among acetonitrile, dimethylsulfoxide, dimethylformamide, and hexamethylphosphoamide.

3. The method of preparing a fluoroalkyl compound using radiation according to claim 1, wherein the leaving group is selected from among a tosyl group, a mesyl group, and a nosyl group.

4. The method of preparing a fluoroalkyl compound using radiation according to claim 1, wherein the tetrabutylammonium fluoride (TBAF) is added such that the equivalent weight thereof is the same as that of the alkyl compound.

5. The method of preparing a fluoroalkyl compound using radiation according to claim 1, wherein an amount of the radiation is 0.1˜30 kGy.

6. The method of preparing a fluoroalkyl compound using radiation according to claim 1, wherein the reaction is performed through a radical mechanism.

7. The method of preparing a fluoroalkyl compound using radiation according to claim 1, wherein the reaction is completed within 1 hour without a heat source.

8. The method of preparing a fluoroalkyl compound using radiation according to claim 1, wherein fluorine (F) present in the tetrabutylammonium fluoride (TBAF) is radioactive fluorine (¹⁸F).
